(19) United States
(12) Patent Application Publication
(10) Pub. No.: US 2005/0163586 A1
(43) Pub. Date: Jul. 28, 2005

(54) Flush break-off blind bolt

(76) Inventors: Emory K. Tamashiro, San Pedro, CA (US); James Eastwood, Torrance, CA (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/028,951

(22) Filed: Jan. 4, 2005

Related U.S. Application Data
(60) Provisional application No. 60/534,261, filed on Jan. 5, 2004.

(51) Int. Cl. F16B 13/04

(52) U.S. Cl. 411/43; 411/34

(57) ABSTRACT

Blind fasteners are used to connect two or more workpieces together, and are particularly useful in aerodynamic designs. In such uses, it is very desirable to have a substantially flush surface. The present fastener comprises a fastener body having an axial bore therethrough and an enlarged head, a corebolt passing through the axial bore, the corebolt having a first portion, a threaded second portion, and a localized weakened region therebetween, a drive nut configured to fit around and threadingly engage the first portion of the corebolt, and a stop member that substantially prevents further withdrawal of the corebolt relative to the drive nut after the corebolt has been driven a predetermined distance during installation to shear the corebolt at the weakened region.

### CROSS-REFERENCE TO RELATED APPLICATIONS

This application claims priority from U.S. Provisional Patent Application No. 60/534,261 filed on Jan. 5, 2004, which is hereby incorporated by reference.

### FIELD OF INVENTION

The present invention relates generally to blind fasteners for use in fastening workpieces together in overlapped outer and inner relation, and more particularly, to blind fasteners that provide positive mechanical engagement during installation of the fastener so that the corebolt break groove shears at a position at or near a fastener body flange head for a flush finish.

### BACKGROUND

Blind fasteners are used in a variety of applications to connect two or more workpieces together. In the construction of aerodynamic designs, such as control surfaces on aircraft and the like, a substantially flush surface usually is desired on the accessible side of the panels while access to the blind side may not be possible. In these cases, the use of a blind fastener is appropriate, since access to only one side of the panel is available to install the fastener.

Typical blind fasteners comprise an internally threaded nut body and an externally threaded cylindrical corebolt or stem passing in threaded engagement through the nut body. The inserted end of the corebolt has an enlarged corebolt head while the other end of the corebolt has a wrench-engaging portion. Thus, upon insertion of the fastener into the aligned apertures of a pair of workpieces and upon turning motion of the corebolt relative to the nut body, the corebolt is moved in an axially outward direction through the nut body. This axially outward movement typically causes a deformable sleeve around the corebolt and intermediate the nut body and corebolt head to deform around the tapered nose of the nut body to provide a blind side head against the inner surface of the inner work piece. The corebolt further is provided with a localized weakened region or break groove adapted to sever the corebolt at a predetermined torque and location.

Other types of fasteners utilize non-threaded fastener bodies and corebolts, such as rivets. These rivets include much of the same structure as identified above. However, where the stem has a threaded section and is pulled through the unthreaded fastener body by a drive nut system to cause the deformable sleeve located intermediate the stem head and the fastener body to deform on the blind side of the inner work piece. Again, the unthreaded to thread transition of the corebolt may be provided with a localized weakened region or break groove adapted to sever the corebolt at a predetermined tension stress.

It is advantageous that the break groove, in either the threaded or non-threaded fasteners or any other fastener configuration, shears the corebolt in a substantially flush relation to the fastener body head after the fastener is fully set. Particularly, accurate corebolt break is sought for fasteners having countersunk body heads to provide a flush relationship between the set fastener and the outer panel, thus providing a smooth aerodynamic surface after the fastener is set.

However, due to numerous factors including over-tightening, sometimes the break groove on the corebolt extends beyond a flush position with the fastener body head. Therefore, when shear or breakage occurs at the break groove, a portion of the remaining corebolt may protrude beyond the fastener body head. It is often necessary to grind the protruding corebolt so that the corebolt is flush with the fastener body head. Prevention of such protrusion will provide a cost savings through the elimination of additional operations and manpower required in shaving, smoothing, and trimming the protruding corebolt stem to provide a flush finish. Several designs have been offered to promote flush breaking of the corebolt stem, such as U.S. Pat. No. 4,752,169 issued on Jun. 21, 1988, hereby incorporated by reference herein, and having common ownership with the present invention.

### SUMMARY OF THE INVENTION

In accordance with the present invention there is provided a fastener comprising, a fastener body having an axial bore therethrough and an enlarged head, a corebolt passing through the axial bore of the fastener body, the corebolt having a first portion, a threaded second portion, and a localized weakened region between the first and second portions, a drive nut configured to fit around and threadingly engage the first portion of the corebolt, and a stop member that substantially prevents further withdrawal of the corebolt relative to the drive nut after the corebolt has been driven a predetermined distance during installation to shear the corebolt at the weakened region.

In another embodiment of the present invention a fastener is disclosed. The fastener comprises a fastener body having an axial bore extending therethrough and an enlarged head, a corebolt passing through the axial bore of the fastener body, the corebolt having a first portion, a threaded second portion, and a break groove located between the first and second portions, a drive nut configured to threadingly engage the second portion of the corebolt and capable of engaging the enlarged head of the fastener body, and means for mechanically engaging the first portion of the corebolt with the drive nut to substantially prevent further withdrawal of the corebolt after the corebolt has been driven a predetermined distance during installation of the fastener to shear the corebolt at the break groove.

### DESCRIPTION OF THE DRAWINGS

Objects and advantages together with the operation of the invention may be better understood by reference to the following detailed description taken in connection with the following illustrations, wherein:

FIG. 1 is a cross-sectional view of a threaded fastener and threaded drive nut according to a first embodiment of the present invention;

FIG. 2 is a cross-sectional view of the corebolt of the first embodiment showing first and second corebolt portions having different diameters prior to creation of threads;

FIG. 3 is a modification of the corebolt of FIG. 2 wherein the corebolt further includes a break groove and optional step;

FIG. 4 is an enlarged view of segment A of FIG. 1 showing the drive nut/fastener body/corebolt interface of the first embodiment;

FIG. 5 is an enlarged segment view of the drive nut/fastener body/corebolt interface of a second embodiment of the invention utilizing a lock ring;

FIG. 6 is an enlarged segment view of the drive nut/fastener body/corebolt interface of a third embodiment of the invention utilizing a deformable feature which engages the fastener body and drive nut and provides a screw stop;

FIG. 7 is an enlarged segment view of the drive nut/fastener body/corebolt interface of a fourth embodiment of the invention utilizing a separate element to provide a screw action stop;

FIG. 8 is a cross-sectional view of a drive nut according to the first embodiment of the invention;

FIG. 9 is a cross-sectional view of a second embodiment of a deformable drive nut; and

FIG. 10 is a rivet-type blind fastener using a thread stem section and a drive nut for mechanical installation with a flush break feature;

### DETAILED DESCRIPTION OF THE INVENTION

The present invention is accomplished by providing a corebolt stem with at least two distinct diameter sections. Particularly, the corebolt section engaging the fastener body is of a larger diameter that the threaded corebolt stem section engaging the drive nut and separated by a break groove. Therefore, as the corebolt is rotated and driven radially outwardly the larger corebolt section engages the drive nut, and is prevented from being driving through the drive nut. Therefore, the torque as applied by the driving tool to the small threaded corebolt section causes the drive load to increase and the corebolt to shear in the predefined break groove at a predetermined position relative to the fastener body head. Further, it is anticipated that the present invention can be utilized with any fastener configuration to provide positive mechanical engagement between the corebolt and the drive nut to provide increased shear or tensile stress in the corebolt to accurately predict corebolt break off for a substantially flush finish.

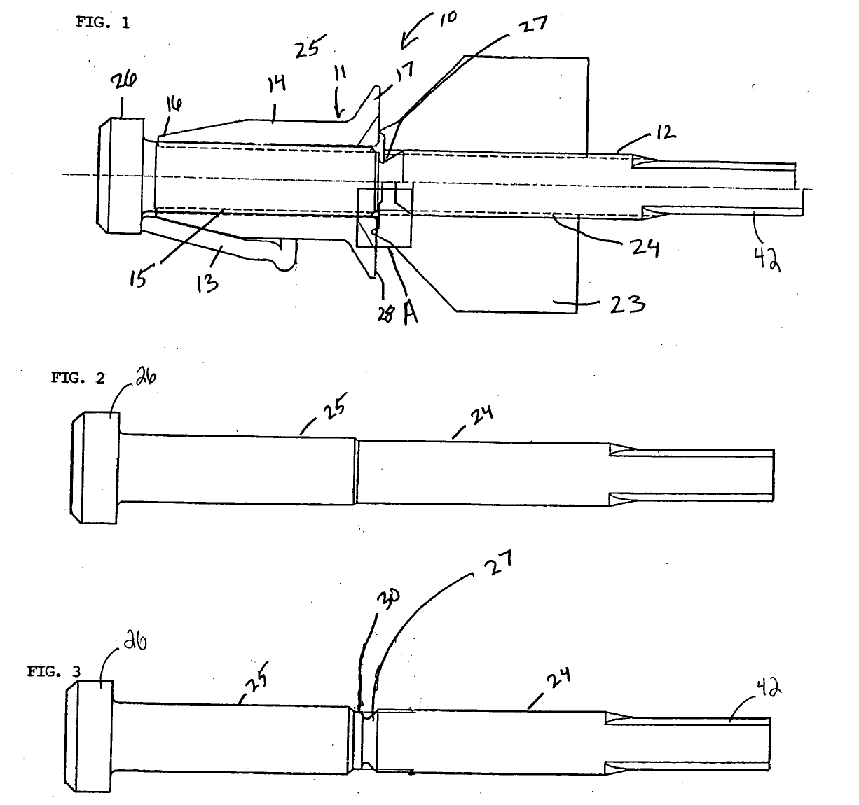

Referring now to FIG. 1 of the drawings, a blind fastener 10 in accordance with the teachings of the invention is shown. Fastener 10 includes a fastener body 11 and a corebolt or stem 12. The fastener 10 may further include a deformable sleeve 13. The fastener body 11 has a body portion 14 with a threaded axial bore 15 therethrough. A nose 16 is provided at one end of the body portion 14 in the preferred form of a conically shaped chamfer having an angle of about 15 degrees to 30 degrees to the axis of fastener body 11.

An enlarged flange head 17 is provided at the other end of the body portion 14. The flange head 17 is adapted to seat in a cavity in the access side of a pair of structural panels or the like being fastened together. The flange head 17 may also be of a protruding type, setting on the surface of the access side panel. The length of fastener body 11 is adapted to extend the external surface of the body portion 14 beyond the blind side of the parts being fastened even in the maximum grip situation by a distance sufficient to permit the thin wall of sleeve 13 to adapt to the external surface of body portion 14, as will be discussed.

The corebolt 12 has a first threaded stem portion 25 extending through fastener body 11 and having an enlarged head 26 at one end thereof (on the blind side). The diameter of head 26 is generally related to the diameter of the body portion 14. The corebolt 12 further comprises a second threaded stem portion 24 extending through the drive nut 23. The thread diameter of the first threaded stem portion 25 is larger than the thread diameter of the second threaded stem portion 24 but has the same pitch, as shown in FIG. 4, so as to act as a screw stop as will be discussed in greater detail below. Corebolt 12 further includes a localized weakened region located between the first threaded stem portion 25 and the second threaded stem portion 24. In particular, as shown in FIG. 1, the localized weakened region is a break groove 27. The break groove 27 causes the corebolt 12 to fracture when a preselected stress is applied to it during installation of the blind fastener 10. Such fracture is designed to occur when the break groove 27 is located flush with or slightly below the surface 28 on the access side of the part being fastened upon completion of the installation of blind fastener 10.

Drive nut 23 may be threaded on the second threaded stem portion 24. Drive nut 23 may also include a deformable portion to engage the flange head 17 so as to help prevent relative rotation between the fastener body 11 and the drive nut 23 as well as to assist in aligning the thread leads of the fastener body 11 and drive nut 23 to prevent lock up.

As particularly contemplated in the present invention, and clearly shown in FIG. 2, the corebolt 12 utilizes a stem having two threaded portions of different thread diameters. As shown in FIG. 3, the break groove 27 can be formed between the two threaded portions 25, 24 and could optionally include a step or unthreaded portion 30.

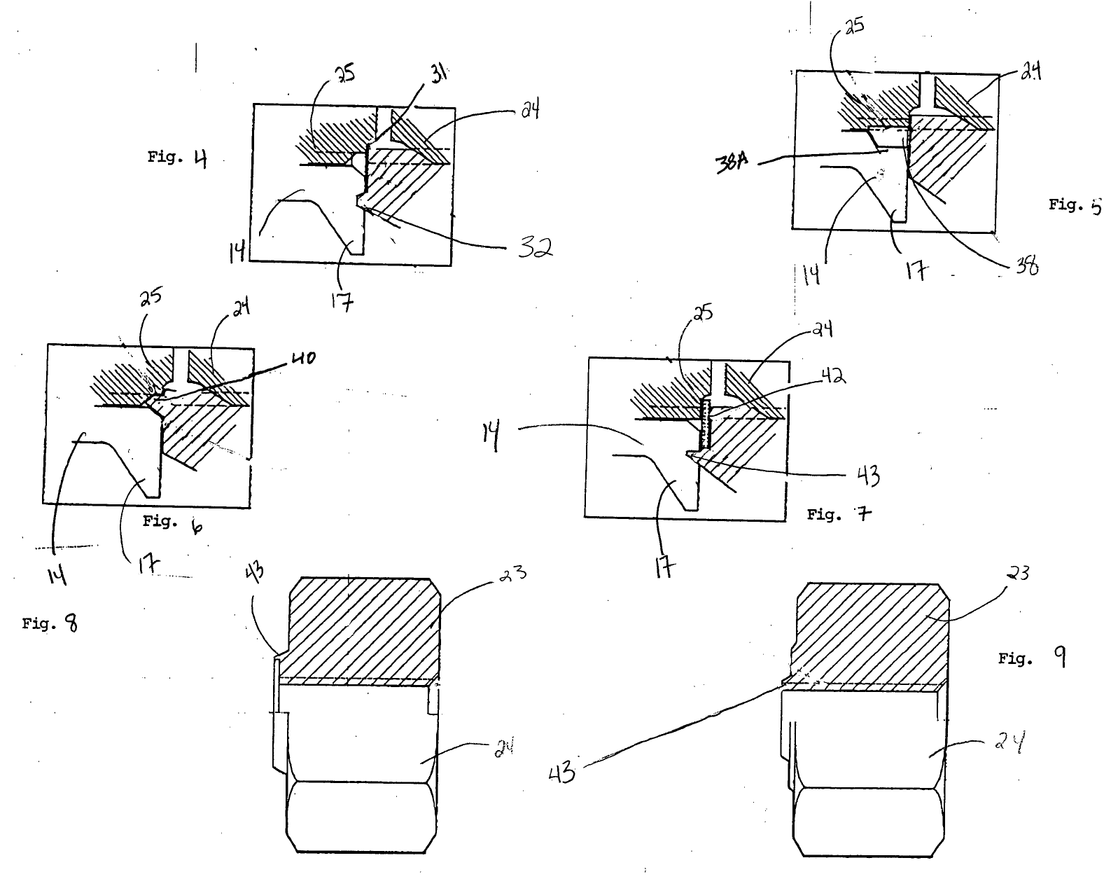

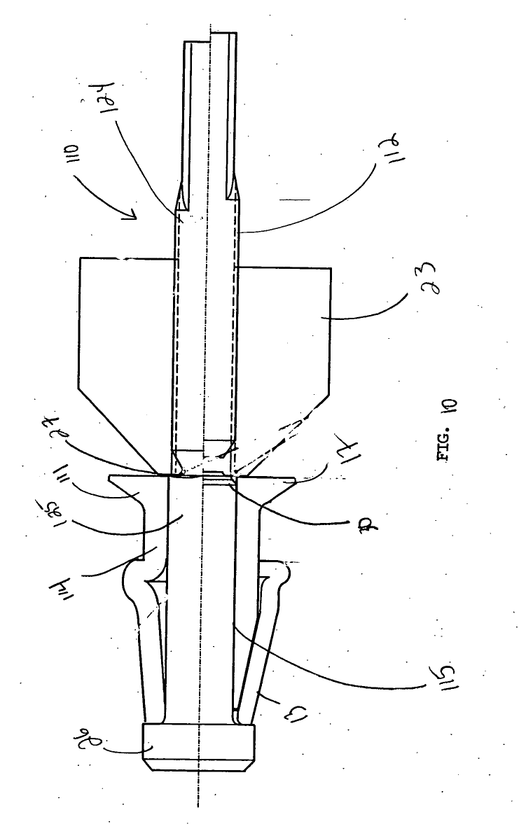

The operation of fastener 10 during installation thereof is shown in FIG. 5 for the fastener of FIG. 1. When the fastener 10 is inserted into the aligned openings of a pair of workpieces, the drive nut 23 is held and a drive tool engages the wrenching flats 42 in order to the turn the corebolt 12 relative to the drive nut 23. The drive nut 23 likewise is designed to engage the flange head 17 so as to prevent relative rotation therebetween, as through the use of a deformable feature 32. Thus, as the corebolt 12 is rotated, the first threaded stem portion 25 is driven through the threaded fastener body 11 and the second threaded stem portion 24 is driven through the drive nut 23 so as to draw the corebolt head 26 toward nose 16 so as to deform the sleeve 13 against the inner surface of the inner workpiece to form a blind side head. Alternatively, however, the fastener 10 may not include a separate deformable sleeve. Instead the fastener body 11 includes a sleeve portion that is integral thereto or just the body portion 14 can be used. The operation of this alternative fastener is the same as previously discussed. As the corebolt 12 is rotated, the first threaded stem portion 25 is driven through the threaded fastener body 11 and the second threaded stem portion 24 is driven through the drive nut 23 so as to draw the corebolt head 26 toward nose 16 so as to deform the sleeve portion or the body portion 14 of the fastener body against the inner surface of the inner workpiece to form a blind side head.

When the corebolt 12 has been driven a predetermined distance, a stop member, such as the step 30, or in the alternative a shoulder 31 of the first stem portion 25, engages the threads of the drive nut 23 so as to substantially prevent further withdrawal of the corebolt 12 relative to the drive nut 23 to shear the corebolt 12 at the break groove 27. Therefore, with the first threaded stem portion 25 held by mechanical engagement with the drive nut 23, the continued torque applied to the second threaded stem portion 24 of the corebolt 12 causes increased torque at the break groove 27 thereby forcing the corebolt 12 to shear a predetermined distance from the flange head 17. Therefore, the present design forces a bolt break at a predetermined position with the head 17 so that the corebolt 12 stem breaks off in a flush relationship therewith.

A second embodiment is shown at FIG. 6 where the stop member comprises a deformable lock ring 38 that prevents relative movement between the fastener body portion 14 and the corebolt 12, acting as a self locking feature after the fastener 10 is installed. Drive nut 23 forces and deforms the locking ring 38 into the cavity between the remaining first threaded stem portion 25 and the inner walls of the fastener body portion 14 in the region 38A. A third embodiment is shown at FIG. 7 wherein the drive nut 23 includes the stop member, which is a deformable feature 40 that engages the first threaded portion 25 so as to prevent further withdrawal of portion 25. It is contemplated that this deformable feature 40 for engaging the first threaded portion 25 could either be integral with the drive nut 23 or be a separate member. A fourth embodiment is shown at FIG. 8 wherein the stop member comprises a separate member 42 that is located between the first threaded portion 25 and the drive nut 23 so as to provide a corebolt screw stop. As shown in FIG. 8, the corebolt screw stop member 42 preferably a washer, stops the withdraw of the first threaded portion 25 relative to the drive nut 23 so as to break the corebolt stem at a predetermined position relative to the head 17. This fourth embodiment may also optionally utilize a deformable portion 43 on the drive nut 23 for engaging the head 17.

An internally threaded blind fastener with a corebolt that breaks off flush with the top of the nut head in a grip condition is shown in the accompanying drawings. Other fastener designs attempt to achieve break-off requirements of 0.000/0.103″ when measured from the top of the installed fastener nut head. The break-off distances can vary within the required limits and still be considered a satisfactory installation, but requires a subsequent milling operation to mill the protruding corebolt flush with the surface of the workpiece. The present design is targeted to provide break-off from approximately 0.000/0.010″ when measured from the top of the installed fastener nut head to eliminate subsequent corebolt milling operations after installation. This improvement will reduce break off distance variation and eliminate the need for subsequent milling operations. Therefore, when installation is complete, the unthreaded portion of the corebolt or step and the smaller thread size of the drivenut prevents further thread engagement, resisting the applied torque resulting in the corebolt breaking off at the break-off-groove with no need for any secondary grinding operation.

Alternatively, as shown in FIG. 11 where it should be understood that for simplicity, like elements are identified by like numbers, the proposed fastener could also be applied to a rivet-type fastener 110. The fastener 110 comprises a corebolt 112 having a first portion 125 and a second portion 124. The first portion 125 is not threaded, whereas the second portion 124 is threaded. Additionally, the first portion 125 has a diameter that is greater than that of the second portion 124. The fastener 110 further comprises a fastener body 111 with a non-threaded axial bore 115 therethrough similar to that of the previous embodiment. Finally, the fastener 110 comprises a drive nut 23 identical to that previously described.

During installation of the fastener 110, the drive nut 23 pulls the second portion 124 which causes the first portion 125 to be pulled through the unthreaded axial bore 115 of the fastener body 112 to cause the deformable sleeve 13 located intermediate the corebolt head 26 and the fastener body 114 to deform on the blind side of the inner work piece. Again, the unthreaded to thread transition of the corebolt 112 may be provided with a localized weakened region or break groove 27 adapted to sever the corebolt 112 at a predetermined tension stress.

Finally, when the corebolt 112 has been driven a predetermined distance, the stop member, or more particularly a step 30, or in the alternative the first portion 125 because of its greater diameter, engages the threads of the drive nut 23 so as to prevent further withdrawal of the corebolt 112. Therefore, with the first portion 125 held by mechanical engagement with the drive nut 23, the continued torque applied to the second portion 124 of the corebolt 112 causes increased torque at the break groove 27 thereby forcing the corebolt 112 to shear a predetermined distance from the flange head 17. Therefore, the present design forces a break at a predetermined position with the flange head 17 so that the corebolt 112 breaks off in a flush relationship therewith.

The invention has been described above and, obviously, modifications and alternations will occur to others upon a reading and understanding of this specification. The claims as follows are intended to include all modifications and alterations insofar as they come within the scope of the claims or the equivalent thereof.

1. A fastener comprising:
a fastener body having an axial bore therethrough and an enlarged head;
a corebolt passing through the axial bore of the fastener body, the corebolt having a first portion, a threaded second portion, and a localized weakened region between the first and second portions;
a drive nut configured to fit around and threadingly engage the first portion of the corebolt; and
a stop member that substantially prevents further withdrawal of the corebolt relative to the drive nut after the corebolt has been driven a predetermined distance during installation to shear the corebolt at the weakened region.

2. The fastener of claim 1, wherein the first portion of the corebolt has a diameter, and the second portion of the corebolt has a diameter smaller than the diameter of the first portion.

3. The fastener of claim 2, wherein the first portion of the corebolt is threaded.

4. The fastener of claim 1, wherein the stop member comprises a separate member located between the first portion of the corebolt and the drive nut.

5. The fastener of claim 4, wherein the separate member is a washer.

6. The fastener of claim 4, wherein the separate member comprises a deformable lock ring.

7. The fastener of claim 1, wherein the stop member is located on the corebolt.

8. The fastener of claim 7, wherein the stop device comprises a shoulder on the first portion of the corebolt.

9. The fastener of claim 7, wherein the stop device comprises a step in the localized weakened region of the corebolt.

10. The fastener of claim 1, wherein stop member comprises a deformable feature on the drive nut that engages the first portion of the corebolt.

11. The fastener of claim 10, wherein the deformable feature is integral with the drive nut.

12. The fastener of claim 3, wherein the stop member comprises threads of the first portion of the corebolt.

13. A fastener comprising:
a fastener body having an axial bore extending therethrough and an enlarged head;
a corebolt passing through the axial bore of the fastener body, the corebolt having a first portion, a threaded second portion, and a break groove located between the first and second portions;
a drive nut configured to threadingly engage the second portion of the corebolt and capable of engaging the enlarged head of the fastener body; and
means for mechanically engaging the first portion of the corebolt with the drive nut to substantially prevent further withdrawal of the corebolt after the corebolt has been driven a predetermined distance during installation of the fastener to shear the corebolt at the break groove.

14. The fastener of claim 13, wherein the first portion of the corebolt has a diameter, and the second threaded portion of the corebolt has a diameter smaller than the diameter of the first portion.

15. The fastener of claim 14, wherein the means for mechanically engaging comprises a separate member located between the first portion of the corebolt and the drive nut.

16. The fastener of claim 14, wherein the means for mechanically engaging comprises a deformable feature on the drive nut that engages the first portion of the corebolt.

17. The fastener of claim 14, wherein the means for mechanically engaging comprises a portion of the corebolt located between the first and second portions.

18. A blind fastener comprising:
a fastener body having an inner end, an enlarged flange head, and an axial bore between the inner end and the enlarged head;
a corebolt passing through the axial bore of the fastener body, the corebolt having a first stem portion having a diameter, a second stem portion having a diameter smaller than the diameter of the first stem portion, and a break groove located between the first and second stem portions;
a deformable sleeve configured to fit around the inner end of the corebolt and to contact the inner end of the fastener body;
an internally threaded drive nut configured to threadingly engage the second portion of the corebolt and to engage the enlarged flange head of the fastener body; and
a stop member that substantially prevents further withdrawal of the corebolt relative to the drive nut by providing positive mechanical engagement between the first portion of the corebolt and the drive nut during installation of the fastener so that after the corebolt is driven a predetermined distance the break groove shears at a position near the fastener body flange head.

19. The fastener of claim 18, wherein the stop member comprises a separate member located between the first portion of the corebolt and the drive nut.

20. The fastener of claim 18, wherein the stop member is located on the corebolt.
